(19) United States
(12) Patent Application Publication
(10) Pub. No.: US 2006/0129631 A1
(43) Pub. Date: Jun. 15, 2006

(54) Method for controlling a media message upload through a wireless communication network

(76) Inventors: Dong Won Na, Sungnam-si (KR); Hong Seo Yoon, Goyang-si (KR); Sang Mok Sohn, Sungnam-si (KR); Woo Jung Yang, Seoul (KR); Sang Gyu Yi, Goori-si (KR)

Correspondence Address: MAYER, BROWN, ROWE & MAW LLP, 1909 K STREET, N.W., WASHINGTON, DC, 20006, US

(21) Appl. No.: 10/542,809

(22) PCT Filed: Jan. 20, 2004
(86) PCT No.: PCT/KR04/00110

§ 371 Date: Jan. 6, 2006

(30) Foreign Application Priority Data
Jan. 20, 2003 (KR) 10-2003-0003711
Jan. 20, 2003 (KR) 10-2003-0003713

(51) Int. Cl. G06F 15/16

(52) U.S. Cl. 709/203

(57) ABSTRACT

A method for controlling a media message upload through a wireless communication network is disclosed. In one aspect of the present invention, when a communication terminal uploads particular media data to an application server, the communication terminal uploads the media data by organizing it into a plurality of segments and one response message is issued by the application server for a predefined number of segments. If an upload error occurs, the upload can be easily resumed without verification of the uploaded data based on a sequence number of a segment provided by the application server. When a data upload is cancelled intentionally befA method for controlling a media message upload through a wireless communication network is disclosed. In one aspect of the present invention, when a communication terminal uploads particular media data to an application server, the communication terminal uploads the media data by organizing it into a plurality of segments and one response message is issued by the application server for a predefined number of segments. If an upload error occurs, the upload can be easily resumed without verification of the uploaded data based on a sequence number of a segment provided by the application server. When a data upload is cancelled intentionally before completed, the data upload can be easily cancelled through an exchange of a request and a response between the communication terminal and the application server.

### 1. TECHNICAL FIELD

The present invention relates to a method for controlling a media message upload through a wireless communication network, and more particularly, but not by way of limitation, to a method for controlling a media message upload that reduces the number of requests and responses exchanged between a communication terminal and a server for fulfilling a normal or resumed upload of the media data through a wireless communication network.

### 2. BACKGROUND ART

In a wireless communication network connected to mobile communication networks and the Internet, voice communication between mobile communication terminals or between a mobile communication terminal and a wired telephone is provided basically and media data uploads and downloads between a mobile communication terminal and a particular server on the network is also feasible through web/WAP connections.

In such a wireless communication network, the HTTP 1.1 (rfc 2616) protocol is required for media data uploads from a mobile communication terminal to a server on the Internet, wherein request messages and response messages are repeatedly issued during a data upload process for verification of the upload.

In the case where a mobile communication terminal uploads particular media data to a server on the wireless network, the mobile communication terminal issues a request message each time it uploads a segment of the media data in accordance with the HTTP 1.1 protocol and the server issues a response message for each request message, thereby performing successive uploads of the segments.

In this scheme, however, data uploading is not efficient in that a request message and a response message need to be issued each time a segment of the media data is uploaded and thus request and response messages are repeatedly exchanged between the mobile communication terminal and the server during the data upload process.

In mobile communications, a data upload error caused by various communication problems may occur during an upload of media data. In this case, to resume the failed data upload from the point at which the error occurred, many request and response messages need to be exchanged between the server and the mobile communication terminal in order to verify the validity of the data that has been already uploaded, which lowers the upload speed and efficiency.

An upload of media data may be stopped before the upload is completed. In this case, it is difficult to resume the stopped upload from the point at which the previous upload was stopped because information indicating where to resume the upload is not available. The upload of the whole media, therefore, should be conducted again despite the fact that a portion of the media data has been already uploaded to the server.

If a data upload error occurs while the mobile communication terminal uploads media data to the server, it is desirable to resume the upload in such a way that the upload is resumed from the point at which the error occurred. However, it is almost impossible for the server to match the previously uploaded data and data to be newly uploaded, which forces the whole data to be uploaded from scratch.

### 3. DISCLOSURE OF INVENTION

It is one object of the present invention to provide a method for controlling a media message upload through a wireless communication network in which the media data is organized into a plurality of segments and one request message and one response message are issued for uploading each group of a predefined number of segments so that the upload efficiency may be enhanced.

It is another object of the present invention to provide a method for controlling a media message upload through a wireless communication network that allows an upload of media data stopped by an upload error to be resumed from the point where the error occurred without any validation process by providing the sequence number of the segment to be uploaded.

It is still another object of the present invention to provide a method for controlling a media message upload through a wireless communication network that allows easy cancellation of a media data upload through an exchange of a request and a response between a communication terminal and a server when the media data upload is cancelled by the communication terminal.

It is yet another object of the present invention to provide a method for controlling a media message upload through a wireless communication network that assigns a unique ID to the message body to be uploaded so that the message body can be easily identified when the data upload is stopped and resumed afterwards.

It is a further object of the present invention to provide a method for controlling a media message upload through a wireless communication network in which a parameter about the range of the message body that has been successfully uploaded is provided to a communication terminal when an upload error occurs and thus the communication terminal is capable of knowing what part of the message body is to be uploaded additionally.

It is a still further object of the present invention to provide a method for controlling a media message upload through a wireless communication network that allows the media data to be uploaded without repeated exchanges of request and response messages between a communication terminal and a server.

It is a yet further object of the present invention to provide a method for controlling a media message upload through a wireless communication network in which a media data upload stopped by an upload error can be resumed based on an error code provided by a server.

A method for controlling a media message upload through a wireless communication network in accordance with one embodiment of the present invention comprises a firs; step, conducted by a communication terminal, of sending a request message for an upload of media data to an application server through the wireless communication network, a second step, conducted by the communication terminal, of uploading the media data by organizing the media data into a plurality of segments until a response message from the application server is received, a third step, conducted by the application server, of sending a response message after receiving a plurality of segments of the media data from the communication terminal, and a fourth step, conducted by the application server, of sending a response message indicating normal completion of the media data upload to the communication terminal if the upload of the media data is completed.

A method for controlling a media message upload through a wireless communication network in accordance with another embodiment of the present invention comprises a first step, conducted by a communication terminal, of sending a request message for an upload of media data to an application server through the wireless communication network, a second step, conducted by the communication terminal, of uploading the media data by organizing the media data into a plurality of segments until a response message from the application server is received, a third step, conducted by the application server, of sending a response message for allowing the upload to be resumed to the communication terminal if an upload error occurs during the upload of the media data, a fourth step, conducted by the communication terminal, of resuming the upload of the media data from the segment to be uploaded, and a fifth step, conducted by the application server, of sending a response message indicating normal completion of the media data upload to the communication terminal if the upload of the media data is completed.

A method for controlling a media message upload through a wireless communication network in accordance with still another embodiment of the present invention comprises a first step, conducted by a communication terminal, of sending a request message for an upload of media data to an application server through the wireless communication network, a second step, conducted by the communication terminal, of uploading the media data by organizing the media data into a plurality of segments until a response message from the application server is received, a third step, conducted by the communication terminal, of sending a request message for querying where to resume the upload to the application server if the connection between the communication terminal and the application server is closed during the upload of the media data, a fourth step, conducted by the application server, of sending, responsive to the request message for querying where to resume the upload, a response message to the communication terminal, a fifth step, conducted by the communication terminal, of resuming the upload of the media data from the segment to be uploaded, and a sixth step, conducted by the application server, of sending a response message indicating normal completion of the media data upload to the communication terminal if the upload of the media data is completed.

A method for controlling a media message upload through a wireless communication network in accordance with yet another embodiment of the present invention comprises a first step, conducted by a communication terminal, of sending a request message for an upload of media data to an application server through the wireless communication network and starting the upload of the media data if a response message is received from the application server, a second step, conducted by the application server, of sending a response message if an upload error occurs during the upload of the media data, a third step, conducted by the communication terminal, of sending a request message for resuming the upload of the media data, a fourth step, conducted by the application server, of sending, responsive to the request message for resuming the upload, a response message to the communication terminal, a fifth step, conducted by the communication terminal, of resuming the upload of the media data if the response message from the application server is received, and a sixth step, conducted by the application server, of sending a response message indicating normal completion of the media data upload to the communication terminal if the resumed upload of the media data is completed.

A method for controlling a media message upload through a wireless communication network in accordance with a further embodiment of the present invention comprises a first step, conducted by a communication terminal, of sending a request message for an upload of media data to an application server through the wireless communication network and starting the upload of the media data if a response message is received from the application server, a second step, conducted by the communication terminal, of sending a request message for querying where to resume the upload to the application server if the connection between the communication terminal and the application server is closed during the upload of the media data, a third step, conducted by the application server, of sending, responsive to the request message for querying where to resume the upload, a response message to the communication terminal, a fourth step, conducted by the communication terminal, of sending a request message for resuming the upload to the application server if the response message from the application server is received, a fifth step, conducted by the application server, of sending, responsive to the request message, a response message to the communication terminal, a sixth step, conducted by the communication terminal, of starting the upload of the media data if the response message from the application server is received, and a seventh step, conducted by the application server, of sending a response message indicating normal completion of the media data upload to the communication terminal after the resumed upload of the media data is completed.

In one embodiment, when a communication terminal uploads particular media data to an application server, the communication terminal uploads the media data by organizing it into a plurality of segments until a response message from the application server is received. In addition, when a media data upload is resumed, the communication terminal resumes the upload based on the sequence number of the segments, thereby improving upload efficiency and speed.

In another embodiment, when a communication terminal uploads media data to an application server, it assigns a unique ID to the message body of the media data so that the message can be identified easily when the upload is stopped and resumed afterwards. When an upload error occurs, a parameter about the range of the message body that has been successfully uploaded is provided by the application server, thereby allowing the communication terminal to know what part of the message body is to be uploaded additionally.

### 4. BRIEF DESCRIPTION OF DRAWINGS

The accompanying drawings, which are included to provide a further understanding of the invention, illustrate the preferred embodiments of the invention, and together with the description, serve to explain the principles of the present invention.

In the drawings:

FIG. 1 illustrates a schematic diagram of a wireless communication network system in which the present invention may be advantageously embodied;

FIG. 2 illustrates the structure of an initial request message for a media data upload in accordance with one embodiment of the present invention;

FIG. 3 illustrates the structure of a response message issued by the application server after receiving a specified number of segments in accordance with one embodiment of the present invention;

FIG. 4 illustrates the structure of a response message issued when the media upload is normally completed in accordance with one embodiment of the present invention;

FIG. 5 illustrates the structure of a response message issued when an upload error occurs while the connection is established in accordance with one embodiment of the present invention;

FIG. 6 illustrates the structure of a request message querying the sequence number of the segment from which the upload should be resumed when the connection is closed in accordance with one embodiment of the present invention;

FIG. 7 illustrates the structure of a response message for the request querying the sequence number in accordance with one embodiment of the present invention;

FIG. 8 illustrates the structure of a request message reporting an upload failure due to cancellation of the upload in accordance with one embodiment of the present invention;

FIG. 9 illustrates the structure of a response message for the cancellation of the upload in accordance with one embodiment of the present invention;

FIG. 10 illustrates a flowchart of the normal procedure for uploading media data in accordance with one embodiment of the present invention;

FIG. 11 illustrates a flowchart of the procedure for resuming an upload of media data stopped by an upload error in accordance with one embodiment of the present invention;

FIG. 12 illustrates a flowchart of the procedure for resuming an upload of media data when the communication connection is reestablished in accordance with one embodiment of the present invention;

FIG. 13 illustrates a flowchart of the procedure for processing an uploaded temporary file when the data upload is forced to stop in accordance with one embodiment of the invention;

FIG. 14 illustrates a flowchart of the procedure for canceling a media data upload in accordance with one embodiment of the present invention;

FIG. 15 illustrates the structure of a request message for a media data upload in accordance with another embodiment of the present invention;

FIG. 16 illustrates the structure of a request message for querying whether the resumption of a stopped media data upload is possible when the communication connection is reestablished in accordance with another embodiment of the present invention;

FIG. 17 illustrates the structure of a request message for resuming a media data upload in accordance with another embodiment of the present invention;

FIG. 18 illustrates the structure of a response message for completing a data upload in accordance with another embodiment of the present invention;

FIG. 19 illustrates the structure of a response message issued in the event of a server error in accordance with another embodiment of the present invention;

FIG. 20 illustrates the structure of a response message issued in the event of a mobile terminal error in accordance with another embodiment of the present invention;

FIG. 21 illustrates the structure of a response message issued in the case where a portion of a media data exists in the server and thus the data upload can be resumed in accordance with another embodiment of the present invention;

FIG. 22 illustrates the structure of a response message issued in the case where a portion of a media data does not exist in the server and thus the data upload should be restarted in accordance with another embodiment of the present invention;

FIG. 23 illustrates the structure of a response message issued when a resumed data upload is completed successfully in accordance with another embodiment of the present invention;

FIG. 24 illustrates a flowchart of the procedure for resuming a failed upload of media data in accordance with another embodiment of the present invention; and

FIG. 25 illustrates a flowchart of the procedure for resuming an upload of media data stopped by a user in accordance with another embodiment of the present invention.

### 5. MODES FOR CARRYING OUT THE INVENTION

In order that the invention may be fully understood, preferred embodiments thereof will now be described with reference to the accompanying drawings.

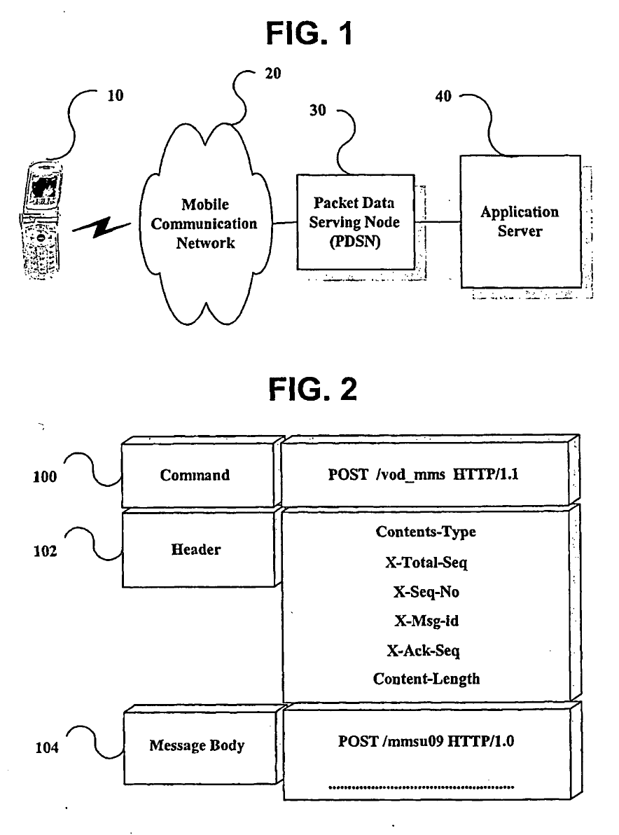

FIG. 1 illustrates a schematic diagram of a wireless communication network system in which the present invention may be advantageously embodied. The wireless communication network system comprises a mobile communication terminal 10, a mobile communication network 20, a packet data serving node (PDSN) 30, and an application server (MMS server) 40.

The mobile communication terminal 10 connects to the application server 40 via the mobile communication network 20 and the wireless Internet and performs an operation for uploading particular media data stored in a memory thereof to the application server 40 in accordance with the HTTP 1.1 protocol.

To upload the media data to the application server 40, the mobile communication terminal 10 issues an upload request message for each group of a predefined number (e.g., K) segments of the media data. In other words, the mobile communication terminal 10 sends an upload request message to the server 40 each time it uploads K segments (one segment is also called a sequence) of the media data. After sending an upload request to the application server 40, the mobile communication terminal 10 sends K segments of the media data and waits for a response message from the application server 40.

If an upload error occurs during the upload process because of various communication problems, the mobile communication terminal 10 tries to resume the upload with reference to a sequence number included in the response message from the application server 40.

If an upload of particular media data is forced to stop by a user while the media data is uploaded, the mobile communication terminal 10 sends a request message for canceling the upload to the application server 40. If the upload is stopped by an unintended communication error, the mobile communication terminal 10 stops the media data upload automatically by calculating the time during which the application server 40 has not responded to the previously issued request message using an internal timer.

The mobile communication network 20 allows voice communications between the mobile communication terminal 10 and another mobile communication terminal or a wired telephone. Also, the mobile communication networks 20 serves as a wireless data transmission route through which the mobile communication terminal 10 uploads the media data to the application server 40.

The packet data serving node (PDSN) 30, which is an interface between the mobile communication network 20 and the wireless Internet, performs routing and tunneling for transmission of packets to/from the mobile communication terminal 10 and assigns an IP address to the mobile communication terminal 10.

The application server 40 connects to the mobile communication terminal 10 via the mobile communication network 20 and the wireless Internet and issues one response message to the mobile communication terminal 10 in response to the upload request each time it receives K segments of data from the mobile communication terminal 10.

If the upload is stopped by an unintended communication error during the upload process, the application server 40 sends a response message containing the sequence number of the segment from which the upload should be resumed to the mobile communication terminal 10, thereby allowing the failed upload to be resumed properly.

If the upload is forced to stop by a user while the media data is uploaded, the mobile communication terminal 10 issues a request message for canceling the upload to the application server 40. In response to the request, the application server 40 sends a response message to the mobile communication terminal 10.

In the case where the upload stops by a communication error while the media data is uploaded and the application server 40 does not receive any message from the mobile communication terminal 10 for a predetermined duration, the application server 40 regards the upload operation as cancelled and deletes the temporary file being uploaded.

When uploading particular media data, the mobile communication terminal 10 issues an initial request message as shown in FIG. 2 comprising a command 100, a header 102, and a message body 104. The command 100 includes MMS 1.0 specification information (e.g., POST/vod_mms HTTP/1.1) and HTTP protocol version information.

The header 102 includes content type information (Contents-Type, e.g., application/vnd.skt.message), the number of total segments in the media data (X-Total-Seq, e.g., 10), the sequence number of the segment to be uploaded (X-Seq-No, e.g., 1), a message ID assigned to the media data to be uploaded (X-Msg-id, e.g., a terminal number and upload time information in the form of MIN_MMDDHHMMSS), the number of segments for which one acknowledgement response will be received from the application server 40 (X-Ack-Seq, e.g., 3), and the length of one segment of the media data given in bytes (Content-Length, e.g., 512).

The fields of ‘X-Total-Seq’, ‘X-Ack-Seq’, and ‘Content-Length’ are sent to the application server 40 only once when the upload is initiated. The ‘X-Ack-Seq’ field, which is the basic unit the reception of which is acknowledged by the application server 40, and the ‘Content-Length’ field, which indicates the length of a segment described in bytes, may be included in the initial and final request messages or in every request message.

The message body 104 includes the first 512 bytes of the MMS 1.0 specification data.

The mobile communication terminal 10 uploads the media data using the concept of sliding windows. To reduce the time for processing request and response messages required for uploading each segment, the mobile communication terminal 10 sends an upload request message to the application server 40 and then uploads a specified number (X-Ack-Seq) of data segments until an acknowledgement message for the upload is received. Receiving a specified number of data segments, the application server 40 sends an acknowledgement message to the mobile communication terminal 10.

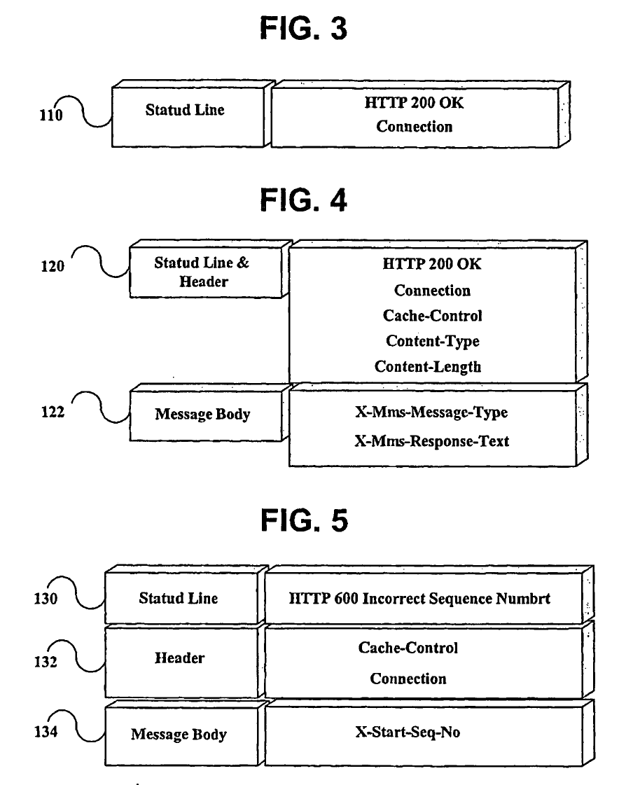

In other words, after receiving segments of a specified number (X-Ack-Seq), the application server 40 sends an acknowledgement response comprising a statud line 110 including a message (e.g., HTTP 200 OK) and a connection status (e.g., Keep-Alive) as shown in FIG. 3 to the mobile communication terminal 10.

If a media data upload from the mobile communication terminal 10 is completed normally, the application server 40 issues a response message comprising a statud line and header 120 and a message body 122 as shown in FIG. 4. The statud line and header 120 includes a message (e.g., HTTP 200 OK), a connection status field (Connection, e.g., Close), a cache control field indicative of the control status of a temporary file of the data being uploaded (Cache-Control, e.g., No-Cache), a content type field (Content-Type, e.g., text/vnd.wap.mmsheaders), and a content length field (Content-Length, e.g., 1234), which is the length of the message body 122.

The message body 122 includes a message type field (X-Mms-Message-Type, e.g., M-send-conf) and an upload result report field (X-Mms-Response-Text, e.g., upload O.K.). The X-Mms-Response-Text field, which is for reporting the final result of the upload initiated by the mobile communication terminal 10, is of a text form. It is also possible to include published information from the application server 40 in the message body 122.

If an upload error occurs while the communication connection is established, the application server 40 generates a response message comprising a statud line 130, a header 132, and a message body 134 as shown in FIG. 5.

The statud line 130 includes a message (e.g., HTTP 600 Incorrect Sequence Number). The header 132 includes a cache control field (Cache-Control, e.g., No-Cache) and a connection status field (Connection, e.g., Keep-Alive). The message body 134 includes the sequence number of the segment from which the upload should be resumed (X-Start-Seq-No, 123).

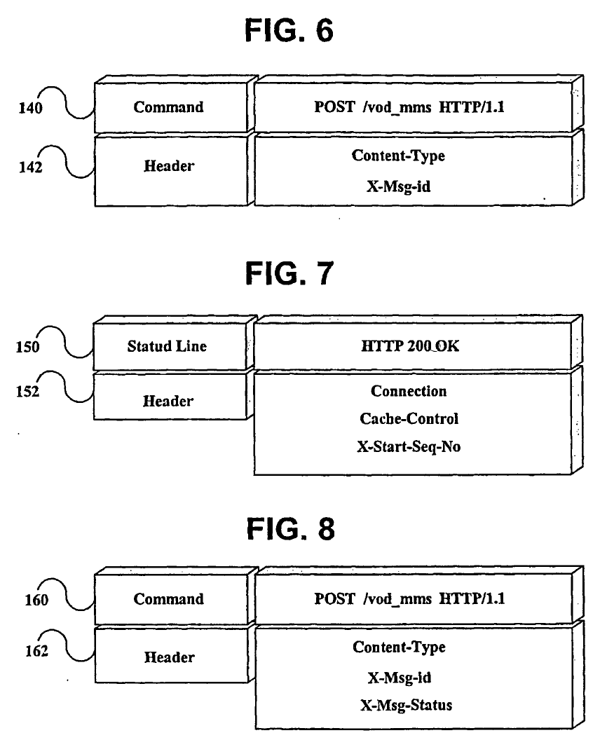

If the connection is broken while media data is uploaded, the mobile communication terminal 10 issues a request message querying the sequence number of the segment from which the upload should be resumed. As shown in FIG. 6, the request message comprises a command 140 including information such as POST/vod_mms HTTP/1.1 and a header 142 including a content type field (Content-Type, e.g., application/vnd.skt.message) and a message ID assigned to the media data that has been uploaded (X-Msg-id, e.g., MIN_MMDDHHMMSS such as 0114261166_{—}0414232012).

Receiving the request message querying the sequence number, the application server 40 issues a response message for the query. As shown in FIG. 7, the response message comprises a statud line 150 and a header 152. The statud line 150 includes a message (e.g., HTTP 200 OK). The header 152 includes a connection status field (Connection, e.g., Keep-Alive), a cache control field (Cache-Control, e.g., No-Cache), and the sequence number of the segment from which the upload should be resumed (X-Start-Seq-No, 123).

If a media data upload is cancelled by a user while being performed, the mobile communication terminal 10 issues a request message informing the application server 40 of the cancellation of the upload. As shown in FIG. 8, the request message comprises a command 160 including information such as POST/vod_mms HTTP/1.1 and a header 162 including a content type field (Content-Type, e.g., application/vnd.skt.message), a message ID assigned to the media data that has been uploaded (X-Msg-id, e.g., MIN_MMDDHHMMSS), and a message status field (X-Msg-Status, e.g., Cancel).

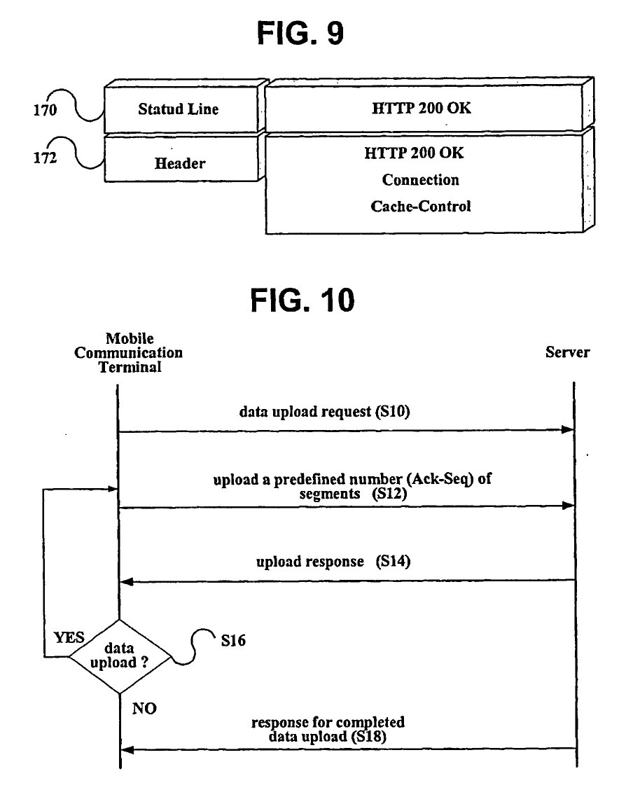

Receiving the request message, the application server 40 issues a response message for the request. As shown in FIG. 9, the response message comprises a statud line 170 including a message (e.g., HTTP 200 OK) and a header 172 including a message (e.g., HTTP 200 OK), a connection status field (Connection, e.g., Close), and a cache control field (Cache-Control, e.g., No-Cache).

FIGS. 10-14 illustrate flow charts in accordance with one embodiment of the present invention.

The normal procedure for uploading media data will be described with reference to the flowchart shown in FIG. 10.

Connected to the application server 40 through the mobile communication network 20 and the packet data serving node (PDSN) 30 (or wireless internet), the mobile communication terminal 10 sends a request message for unloading particular media data to the application server 40, the request message comprising the command 100, the header 102 including the number of total segments of the media data (X-Total-Seq), the sequence number of the segment to be uploaded (X-Seq-No, e.g., 1), and a message ID, and the message body 104 as shown in FIG. 2 (S10).

The mobile communication terminal 10 sequentially uploads as many segments of the media data as is specified by the X-Ack-Seq field included in the request message (S12).

Receiving K segments as specified in the request message, the application server 40 sends a response message comprising the statud line 110 as shown in FIG. 3 to the mobile communication terminal 10 (S14).

Receiving the response message from the application server 40, the mobile communication terminal 10 determines whether to upload the next K segments of the media data (S16).

If it is necessary to upload the next K segments, the steps S12 through S16 are repeated until all segments of the media data are uploaded.

If the media data upload is completed normally, the application server 40 sends a response message comprising the statud line and header 120 including a connection status, a cache control, a content type, and content length and the message body 122 including the message type of data and the text-formatted upload result as shown in FIG. 4 to the mobile communication terminal 10 (S18).

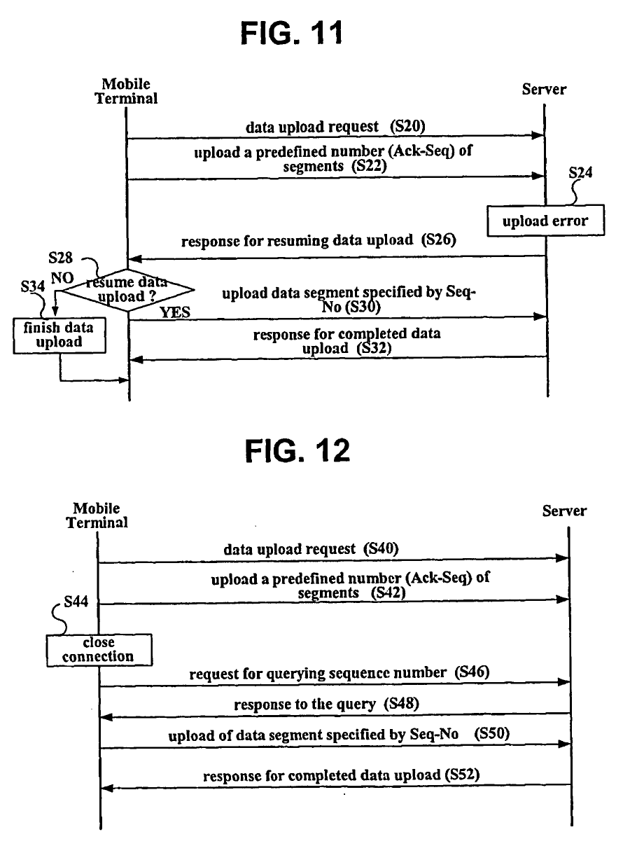

The procedure for resuming an upload of media data stopped by an upload error will be described with reference to the flowchart shown in FIG. 11.

Connected to the application server 40 through the mobile communication network 20 and the packet data serving node (PDSN) 30 (or wireless internet), the mobile communication terminal 10 sends a request message for uploading particular media data to the application server 40, the request message comprising the command 100, the header 102 including the number of total segments of the media data (X-Total-Seq), the sequence number of the segment to be uploaded (X-Seq-No, e.g., 1), and a message ID, and the message body 104 as shown in FIG. 2 (S20).

The mobile communication terminal 10 sequentially uploads as many segments of the media data as is specified by the X-Ack-Seq field included in the request message (S22).

If an upload error occurs while the communication connection is established (S24), the application server 40 generates a response message for allowing the mobile communication terminal 10 to resume the failed upload, the response message comprising the statud line 130, the header 132, and the message body 134 including the sequence number of the segment from which the upload should be resumed as shorn in FIG. 5 (S26).

The mobile communication terminal 10 inquires of the user whether to resume the stopped upload (S28). If confirmed by the user, the mobile communication terminal 10 resumes the upload with reference to the sequence number included in the response message from the application server 40 (S30).

If the resumed media data upload is completed normally, the application server 40 sends a response message comprising the statud line and header 120 including a connection status, a cache control, a content type, and content length and the message body 122 including the message type of data and the text-formatted upload result as shown in FIG. 4 to the mobile communication terminal 10 (S32).

If the resumption of the upload is not approved by the user at Step S28, the mobile communication terminal 10 finishes the media data upload immediately (S34).

The procedure for resuming an upload of media data when the communication connection is reestablished will be described in detail with reference to the flowchart shown in FIG. 12.

Connected to the application server 40 through the mobile communication network 20 and the packet data serving node (PDSN) 30 (or wireless internet), the mobile communication terminal 10 sends a request message for uploading particular media data to the application server 40, the request message comprising the command 100, the header 102 including the number of total segments in the media data (X-Total-Seq), the sequence number of the segment to be uploaded (X-Seq-No, e.g., 1), and a message ID, and the message body 104 as shown in FIG. 2 (S40).

The mobile communication terminal 10 sequentially uploads as many segments of the media data as is specified by the X-Ack-Seq field included in the request message (S42).

If the mobile communication terminal 10 gets disconnected from the application server 40 and as a result an upload error occurs (S44), the mobile communication terminal 10 sends a request message querying the sequence number of the segment from which the upload should be resumed to the application terminal 40, the request message comprising the command 140 and the header 142 including a content type and a message ID as shown in FIG. 6 (S46).

Receiving the request message querying the sequence number, the application server 40 issues a response message for the query. As shown in FIG. 7, the response message comprises the statud line 150 and the header 152 including a connection status, a cache control, and the sequence number of the segment from which the upload should be resumed (S48).

The mobile communication terminal 10 resumes the upload with reference to the sequence number included in the response message from the application server 40 (S50).

If the resumed media data upload is completed normally, the application server 40 sends a response message comprising the statud line and header 120 including a connection status, a cache control, a content type, and content length and the message body 122 including the message type of data and the text-formatted upload result as shown in FIG. 4 to the mobile communication terminal 10 (S52).

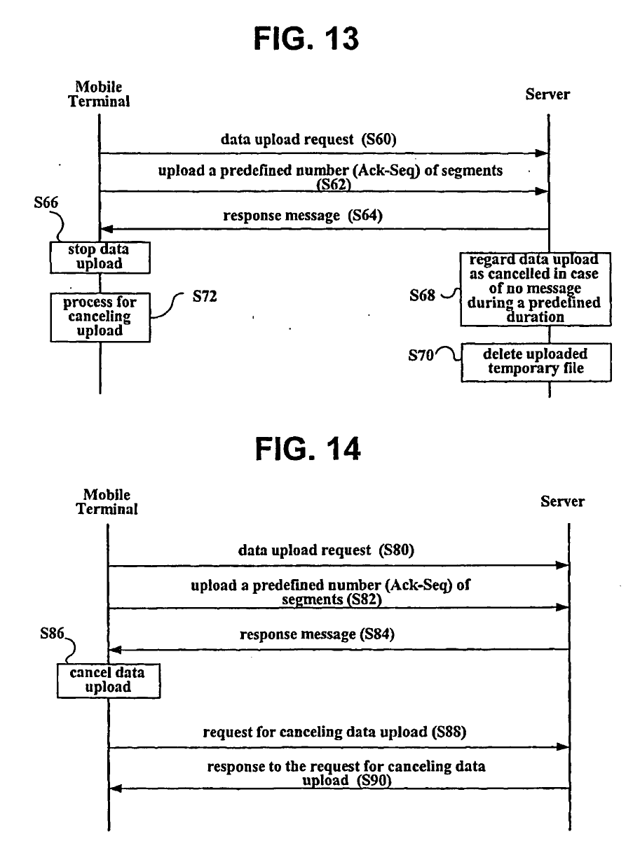

The procedure for processing an uploaded temporary file when the data upload is forced to stop will be described in detail with reference to the flowchart shown in FIG. 13.

Connected to the application server 40 throuch the mobile communication network 20 and the packet data serving node (PDSN) 30 (or wireless internet), the mobile communication terminal 10 sends a request message for unloading particular media data to the application server 40, the request message comprising the command 100, the header 102 including the number of total segments in the media data (X-Total-Seq), the sequence number of the segment to be uploaded (X-Seq-No, e.g., 1), and a message ID, and the message body 104 as shown in FIG. 2 (S60).

The mobile communication terminal 10 sequentially uploads as many segments of the media data as is specified by the X-Ack-Seq field included in the request message (S62).

Receiving K segments as specified in the request message, the application server 40 sends a response message including the statud line 110 as shown in FIG. 3 to the mobile communication terminal 10 (S64).

If the upload is terminated by an error of the mobile communication terminal 10 (S66), the application server 40 does not receive any request message from the mobile communication terminal 10 for a predetermined duration. In this case, the application server 40 concludes that the mobile communication terminal 10 cancelled the upload (S68) and deletes the temporary file that has been received thus far (S70). The application server 40 does not issue a response message.

The mobile communication terminal 10 cancels the upload automatically if it does not receive a response message from the application server 40 for a predetermined duration (S72).

The procedure for canceling an upload that has been performed will be described in detail with reference to the flowchart shown in FIG. 14.

Connected to the application server 40 through the mobile communication network 20 and the packet data serving node (PDSN) 30 (or wireless internet), the mobile communication terminal 10 sends a request message for uploading particular media data to the application server 40, the request message comprising the command 100, the header 102 including the number of total segments in the media data (X-Total-Seq), the sequence number of the segment to be uploaded (X-Seq-No, e.g., 1), and a message ID, and the message body 104 as shown in FIG. 2 (S80).

The mobile communication terminal 10 sequentially uploads as many segments of the media data as is specified by the X-Ack-Seq field included in the request message (S82).

Receiving K segments as specified in the request message, the application server 40 sends a response message comprising the statud line 110 as shown in FIG. 3 to the mobile communication terminal 10 (S84).

If the upload is cancelled by a user of the mobile communication terminal 10 while the media data is uploaded (S86), the mobile communication terminal 10 sends a request message as shown in FIG. 8 to the application server 40, the request message comprising the command 160 and the header 162 including a content type, a message ID, and a message status (S88).

Receiving the request message, the application server 40 issues a response message for the request as shorn in FIG. 9, the response message comprising the statud line 170 and the header 172 including a connection status and a cache control (S90).

Another embodiment of the present invention will now be described with reference to the accompanying drawings, in which the components of the wireless communication network system shown in FIG. 1 will be referenced with the same number.

The mobile communication terminal 10 connects to the application server 40 via the mobile communication network 20 and the wireless Internet, uploads particular media data stored in a memory thereof to the application server 40 in accordance with POST and HEAD (or GET) methods of the HTTP 1.1 protocol, and performs operations to resume a stopped or failed upload.

When generating a request message for uploading the particular media data, the mobile communication terminal 10 assigns a unique ID of the message body to the header of the message, thereby allowing the application server 40 to match one portion of the message body that has been already uploaded and the other portion of the message body to be uploaded in the case where the upload of the media data is resumed.

If an upload error occurs during the media data upload because of various communication problems, the mobile communication terminal 10 examines whether a portion of the media data that has been already uploaded exists in the application server 40 using the unique ID of the message body and resumes the upload if available.

The application server 40 connects to the mobile communication terminal 10 via the mobile communication network 20 and the wireless Internet and issues a response message in response to the upload request, the response message allowing the mobile communication terminal 10 to resume the stopped media data upload.

If a data upload is stopped by an unintended communication error during the upload process, or the mobile communication terminal 10 tries to resume an upload cancelled by the user, the application server 40 sends a response message including the range of the message body that has been uploaded successfully before the upload error or upload cancellation to the mobile communication terminal 10 to allow the stopped data upload to be resumed.

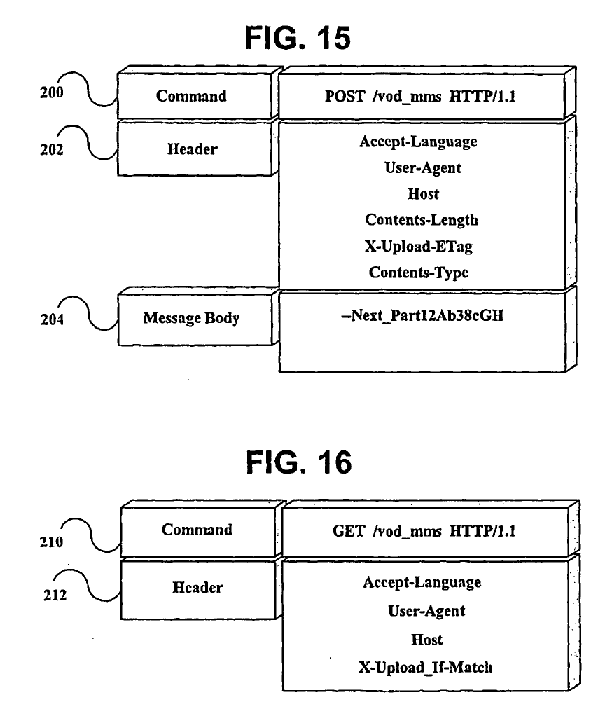

When uploading particular media data, the mobile communication terminal 10 issues a request message as shown in FIG. 15 comprising a command 200, a header 202, and a message body 204. The command 200 includes MMS 1.0 specification information (e.g., POST/vod_mms HTTP/1.1) and HTTP protocol version information.

The header 202 includes information on used languages (Accept-Language, e.g., en, ko), user agent information (User-Agent, e.g., SKT/XXX200), a host name (Host, e.g., ‘vmms.domain name’), content length given in bytes (Contents-Length, e.g., 1500), the ID of the message body to be uploaded (X-Upload-Etag, e.g., a terminal number and upload time information in the form of MIN_MMDDHHMMSS such as 0114261166_{—}0414232012), and contents type information (Contents-Type, e.g., multipart/mixed;boundary=Next_Part12Ab38cGH).

In FIG. 15, the message body 204 is defined within 64 bytes in accordance with the message body format of the MMS 1.0 specification, which is unique throughout the message.

To resume a media data upload that has been stopped by the user, the mobile communication terminal 10 connects to the application server 40 again and issues a request message comprising a command 210 (e.g., GET/vod_mms HTTP/1.1) and a header 212 as shown in FIG. 16. The header 212 includes information on used languages (Accept-Language, e.g., ko), user agent information (User-Agent, e.g., SKT/XXX200), a host name (Host, e.g., ‘vmms.domain name’), and information for checking whether the portion of the message body (Upload-Etag) that was previously uploaded exists (X-Upload-If-Match, a terminal number and upload time information in the form of MIN_MMDDHHMMSS such as 0114261166_{—}0414232012).

Receiving the request message, the application server 40 issues a response message including the range of the message body that should be additionally uploaded if the previously uploaded portion exists. If not, the response message includes a message such as ‘503 Service Unavailable’.

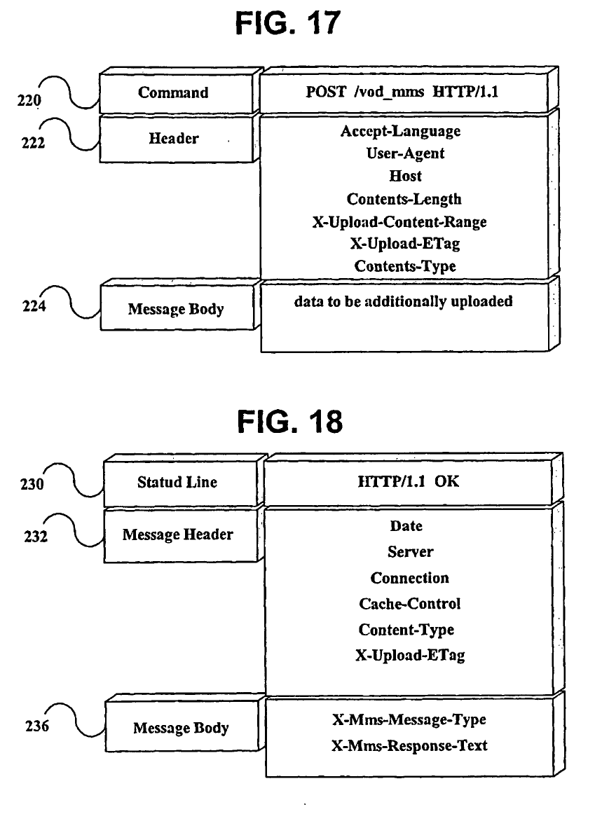

The mobile communication terminal 10 issues a request message depending on the response message from the application server 40. As shown in FIG. 17, the request message comprises a command 220, a header 222, and a message body 224. The command 220 includes MMS 1.0 specification information (e.g., POST/vod_mms HTTP/1.1) and HTTP protocol version information.

The header 222 includes information on used languages (Accept-Language, e.g., en, ko), user agent information (User-Agent, e.g., SKT/XXX200), a host name (Host, e.g., vmms.domain name), content length given in bytes (Contents-Length, e.g., 500), content range information indicating the range of the content to be uploaded by the resumed upload operation (X-Upload-Content-Range, e.g., 1001-1500/1500 (where 1500 is the size of the whole data)), the ID of the message body that is to be re-uploaded (X-Upload-Etag, e.g., a terminal number and upload time information in the form of MIN_MMDDHHMMSS such as 0114261166_{—}0414232012), and content type information (contents-Type, e.g., multipart/mixed;boundary=Next_Part12Ab38cGH).

The message body 226 includes the data to be additionally uploaded in accordance with the message body format of the MMS 1.0 specification.

If the media data upload from the mobile communication terminal 10 is completed normally, the application server 40 issues a response message comprising a statud line 230, a message header 232, and a message body 236 as shown in FIG. 18.

The statud line 230 includes a message (e.g., HTTP/1.1 OK). The header 232 includes date information (Date, e.g., Sun, 08 Apr 18:46:12 GMT), server information (Server, e.g., video MMSC (Unix)), a connection status field (Connection, e.g., Close), a cache control field indicative of the control status of a temporary file of the data being uploaded (Cache-Control, e.g., No-Cache), a content type field (Content-Type, e.g., text/vnd.wap.mmsheaders), the message body ID (X-Upload-Etag, e.g., a terminal number and upload time information in the form of MIN_MMDDHHMMSS), and a content length field (Content-Length, e.g., 50), which is the length of the message body.

The message body 236 includes a message type field (X-Mms-Message-Type, e.g., M-send-conf) and an upload result report field (X-Mms-Response-Text, e.g., upload O.K.). The X-Mms-Response-Text field, which is for reporting the final result of the upload initiated by the mobile communication terminal 10, is of a text form. The message body 236 may include published information from the application server 40.

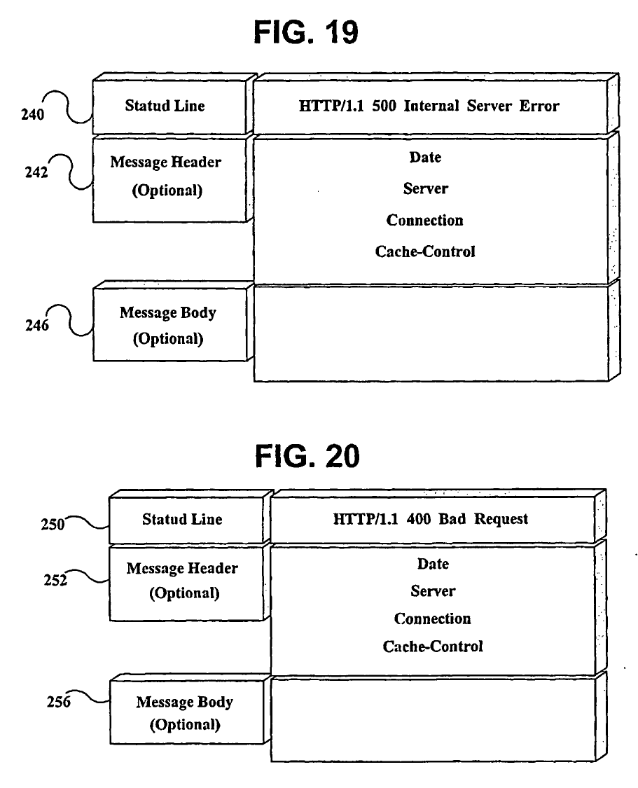

If an upload error by the application server 40 occurs while the media data is uploaded, the application server 40 issues a response message comprising a statud line 240, a message header 242, and a message body 246 as shown in FIG. 19.

The statud line 240 includes a message (e.g., HTTP/1.1 500 Internal Server Error). The header 242 includes date information (Date, e.g., Sun, 08 Apr 18:46:12 GMT), server information (Server, e.g., video MMSC (Unix)), a connection status field (Connection, e.g., Close), and a cache control field indicative of the control status of a temporary file of the data being uploaded (Cache-Control, e.g., No-Cache).

On the other hand, if an upload error due to the mobile communication terminal 10 occurs while the media data is uploaded, the application server 40 issues a response message comprising a statud line 250, a message header 252, and a message body 256 as shown in FIG. 20.

The statud line 250 includes a message (e.g., HTTP/1.1 400 Bad Request). The header 252 includes date information (Date, e.g., Sun, 08 Apr 18:46:12 GMT), server information (Server, e.g., video MMSC (Unix)), a connection status field (Connection, e.g., Close), and a cache control field indicative of the control status of a temporary file of the data being uploaded (Cache-Control, e.g., so-Cache).

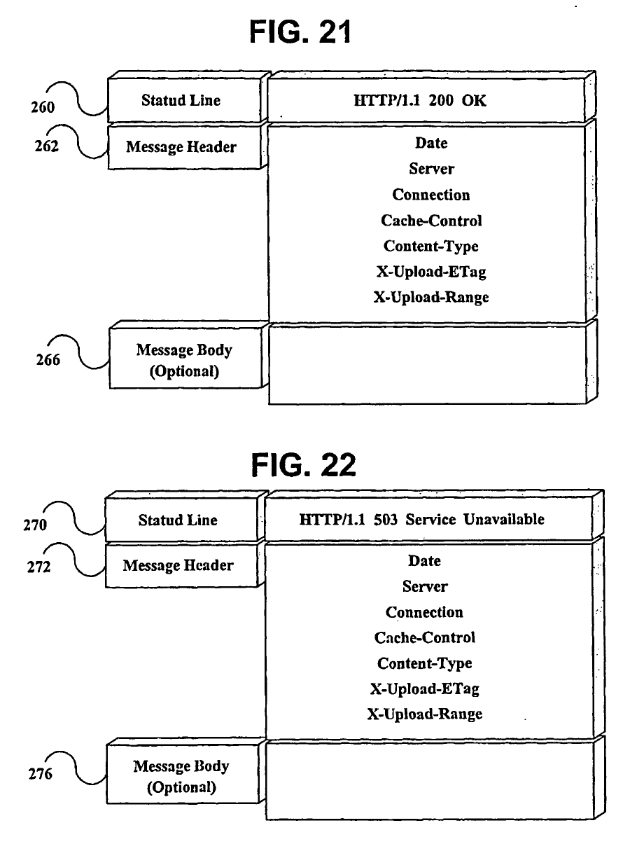

Receiving a request message querying where the upload should be resumed, the application server 40 issues a response message comprising a statud line 260, a message header 262, and a message body 266 as shown in FIG. 21 if a previously uploaded portion of the media data exists.

The statud line 260 includes a message (e.g., HTTP/1.1[SP]200[SP]OK[CRLF]). The header 262 includes date information (Date, e.g., Sun, 08 Apr 18:46:12 GMT), server information (Server, e.g., video MMSC (Unix)), a connection status field (Connection, e.g., Close), a cache control field indicative of the control status of a temporary file of the data being uploaded (Cache-Control, e.g., No-Cache), a content type field (Content-Type, e.g., text/vnd.wap.mmsheaders), the message body ID (X-Upload-Etag, e.g., MIN_MMDDHHMMSS), and the range of the content that has been uploaded successfully before the upload error (X-Upload-Range, e.g., 1-1000/1500).

Receiving a request message querying where the upload should be resumed, the application server 40 issues a response message comprising a statud line 270, a message header 272, and a message body 276 as shown in FIG. 22 if a previously uploaded portion of the media data does not exist in the server.

The statud line 270 includes a message (e.g., HTTP/1.1 503 Service Unavailable). The header 272 includes date information (Date, e.g., Sun, 08 Apr 18:46:12 GMT), server information (Server, e.g., video MMSC (Unix)), a connection status field (Connection, e.g., Close), a cache control field indicative of the control status of a temporary file of the data being uploaded (Cache-Control, e.g., No-Cache), a content type field (Content-Type, e.g., text/vnd.wap.mmsheaders), the message body ID (X-Upload-Etag, e.g., MIN_MMDDHHMMSS), and the range of the content that has been uploaded successfully before the upload error (X-Upload-Range, e.g., 1-1000/1500).

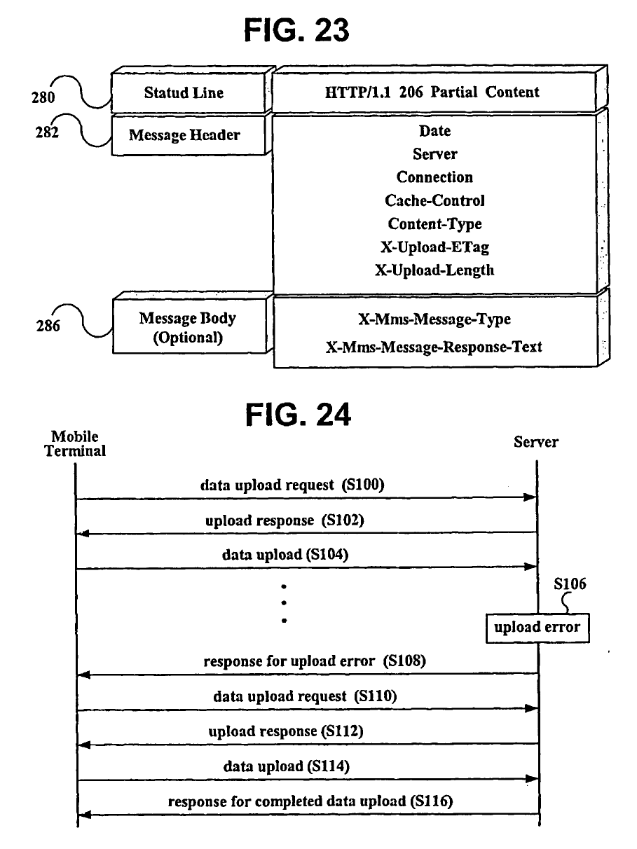

If the resumed media data upload from the mobile communication terminal 10 is completed normally, the application server 40 issues a response message comprising a statud line 280, a message header 282, and a message body 286 as shown in FIG. 23.

The statud line 280 includes a message (e.g., HTTP/1.1 206 Partial Content). The header 282 includes date information (Date, e.g., Sun, 08 Apr 18:46:12 GMT), server information (Server, e.g., video MMSC (Unix)), a connection status field (Connection, e.g., Close), a cache control field indicative of the control status of a temporary file of the data being uploaded (Cache-Control, e.g., No-Cache), a content type field (Content-Type, e.g., text/vnd.wap.mmsheaders), the message body ID (X-Upload-Etag, e.g., MIN_MMDDHHMMSS), and a content length field (Content-Length, e.g., 50), which is the length of the message body.

The message body 286 includes a message type field (X-Mms-Message-Type, e.g., M-send-conf) and an upload result report-field (X-Mms-Response-Text, e.g., upload O.K.). The X-Mms-Response-Text field, which is for reporting the final result of the upload initiated by the mobile communication terminal 10, is of a text form. The message body 286 may include an announcement from the application server 40.

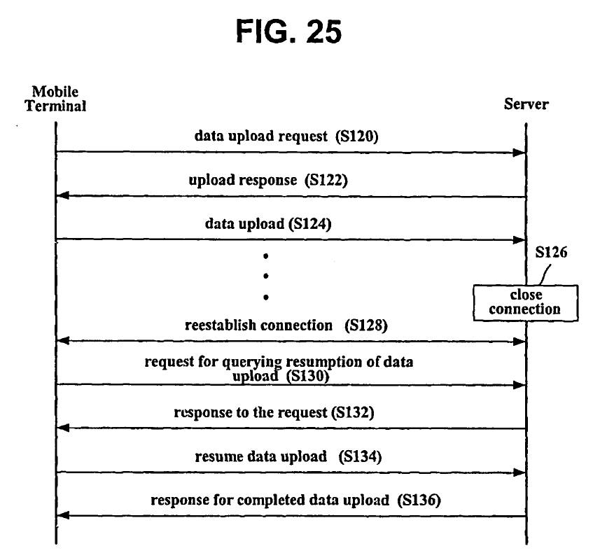

FIGS. 24-25 illustrate flow charts in accordance with another embodiment of the present invention.

The procedure for resuming an upload of media data stopped by an upload error will be described with reference to the flowchart shown in FIG. 24.

Connected to the application server 40 through the mobile communication network 20 and the packet data serving node (PDSN) 30 (or wireless internet), the mobile communication terminal 10 sends a request message for uploading particular media data to the application server 40, the request message comprising the command 200, the header 202, and the message body 206 as shown in FIG. 15 (S100). The header 202 includes a unique ID of the message body 206.

Receiving the request message, the application server 40 sends a response message to the mobile communication server 10 (S102). Receiving the response message, the mobile communication terminal 10 begins to upload the message body 206 of the media data (S104).

The mobile communication terminal 10 and the application server 40 repeatedly exchanges request messages including the unique ID of the message body and response messages during the upload of the media data.

If the media data upload fails due to an error caused by the mobile communication terminal 10 or the application server 40 (S106), the application server 40 sends a response message comprising the statud line 240, the message header 242 including connection status and cache control information, and the message body 246 as shown in FIG. 19 to the mobile communication terminal 10 (S108).

The mobile communication terminal 10 then sends a request message including the length of the content to be uploaded additionally, the range of the content to be uploaded additionally, the message body ID, and content type as shown in FIG. 17 to the application server 40 (S110).

Receiving the request message from the mobile communication terminal 10, the application server 40 sends a response message including the message body ID and the range of data that has been already uploaded as shown in FIG. 21 to the mobile communication terminal 10 (S112).

If the mobile communication terminal 10 receives the response message from the application server 40, it begins uploading a portion of the media data that needs to be uploaded additionally (S114).

If the resumed upload of the media data is completed normally, the application server 40 sends a response message comprising the statud line 280, the message header 282, and the message body 286 including the upload result report as shown in FIG. 23 to the mobile communication terminal 10 (S116).

The procedure for resuming an upload of media data stopped by a closed connection will be described with reference to the flowchart shown in FIG. 25.

Connected to the application server 40 through the mobile communication network 20 and the packet data serving node (PDSN) 30 (or wireless internet), the mobile communication terminal 10 sends a request message for uploading particular media data to the application server 40, the request message comprising the command 200, the header 202, and the message body 206 as shown in FIG. 15 (S120). The header 202 includes a unique ID of the message body 206.

Receiving the request message, the application server 40 sends a response message to the mobile communication server 10 (S122). Receiving the response message, the mobile communication terminal 10 begins to upload the message body 206 of the media data (S124).

The mobile communication terminal 10 and the application server 40 repeatedly exchanges request messages including the unique ID of the message body and response messages during the upload of the media data.

After the user of the mobile communication terminal 10 closes the connection between the mobile communication terminal 10 and the application server 40 (S126), the connection between them gets reestablished afterwards (S126).

To resume the incomplete media data upload, the mobile communication terminal 10 issues a request message for querying where to resume the upload. As shown in FIG. 16, the request message comprises a header including information querying whether a portion of the message body that was previously uploaded exists in the application server 40 (S130).

Receiving the request message from the mobile communication terminal 10, the application server 40 issues a response message comprising a statud line, a message header including the range of data that has been uploaded already, and a message body as shown in FIG. 21 or FIG. 22 (S132).

Receiving the response message, the mobile communication terminal 10 then sends a request message for resuming the cancelled upload, comprising the command 220 and the header 222 including the length of the content to be uploaded additionally and the range of the content to be unloaded additionally as shown in FIG. 17 to the application server 40.

If the mobile communication terminal 10 receives the response message from the application server 40, it begins uploading a portion of the media data that needs to be uploaded additionally (S134).

If the resumed upload of the media data is completed normally, the application server 40 sends a response message comprising the statud line 280, the message header 282, and the message body 286 including the upload result report as shown in FIG. 23 to the mobile communication terminal 10 (S136).

Yet another embodiment of the present invention will now be described with reference to the accompanying drawings, in which the components of the wireless communication network system shown in FIG. 1 will be referenced with the same number.

In wireless data communications using the TCP protocol, it is not necessary for the application layer sending multimedia data to perform data verification for guaranteeing the integrity of data transmission each time a data packet is sent or received.

In yet another embodiment of the present invention employing the TCP protocol, therefore, a mobile communication terminal uploads only the media data to an application server without receiving a response message from the application server each time a predefined number of segments are uploaded.

The mobile communication terminal and the application server exchanges only one request message and one response message in the message uploading process, thereby reducing the traffic between the mobile communication terminal and the application server effectively.

In case of an upload error, the application server sends a predefined error code to the mobile communication terminal. Receiving the error code, the mobile communication terminal resumes the data upload in a predefined manner.

Connected to the application server 40 through the mobile communication network 20 and the packet data serving node (PDSN) 30, the mobile communication terminal 10 keeps uploading particular media data stored in an internal memory without receiving a response message from the application server 40.

Even though an expected upload error occurs during the data upload, the mobile communication terminal 10 continues the data upload to the application server 40.

If the mobile communication terminal 10 receives a predefined error code from the application server 40, the mobile communication terminal 10 resumes the data upload in a predefined manner (e.g., upload of the whole data or upload of the data from a particular position).

Connected to the mobile communication terminal 10 through the mobile communication network 20 and the packet data serving node (PDSN) 30, the application server 40 keeps receiving media data sent from the mobile communication terminal 10 without issuing a response message.

If an upload error occurs during the data upload, the application server 40 sends a predefined error code to the mobile communication terminal 10 so that the mobile communication terminal 10 may retry the data upload in a predefined manner.

While the invention has been disclosed with respect to a limited number of embodiments, those skilled in the art, having the benefit of this disclosure, will appreciate numerous modifications and variations therefrom. It is intended that all such modifications and variations fall within the spirit and scope of the invention.

1. A method for controlling a media message upload through a wireless communication network, comprising the steps of:
a first step, conducted by a communication terminal, of sending a request message for an upload of media data to an application server through the wireless communication network;
a second step, conducted by the communication terminal, of uploading the media data by organizing the media data into a plurality of segments until a response message from the application server is received;
a third step, conducted by the application server, of sending a response message after receiving a plurality of segments of the media data from the communication terminal; and
a fourth step, conducted by the application server, of sending a response message indicating normal completion of the media data upload to the communication terminal if the upload of the media data is completed.

2. The method set forth in claim 1, wherein the request message sent by the communication terminal in the first step includes the number of total segments in the media data to be uploaded, the sequence number of the segment to be uploaded, a message ID of the media data, the number of segments for which one acknowledgement response will be received from the application server, and the size of the segment to be uploaded given in bytes.

3. The method set forth in claim 2, wherein in the first step, the message ID included in the request message corresponds to a unique ID of the communication terminal and upload time.

4. The method set forth in claim 2, wherein in the first step, the number of total segments in the media data to be uploaded and the sequence number of the segment to be uploaded are included only in an initial request message and the size of the segment to be upload is included only in the initial and final request messages.

5. A method for controlling a media message upload through a wireless communication network, comprising the steps of:
a first step, conducted by a communication terminal, of sending a request message for an upload of media data to an application server through the wireless communication network;
a second step, conducted by the communication terminal, of uploading the media data by organizing the media data into a plurality of segments until a response message from the application server is received;
a third step, conducted by the application server, of sending a response message for allowing the upload to be resumed to the communication terminal if an upload error occurs during the upload of the media data;
a fourth step, conducted by the communication terminal, of resuming the upload of the media data from the segment to be uploaded; and
a fifth step, conducted by the application server, of sending a response message indicating normal completion of the media data upload to the communication terminal if the upload of the media data is completed.

6. The method set forth in claim 5, wherein the request message sent by the communication terminal On the first step includes the number of total segments in the media data to be uploaded, the sequence number of the segment to be uploaded, a message ID of the media data, the number of segments for which one acknowledgement response will be received from the application server, and the size of the segment to be uploaded given in bytes.

7. The method set forth in claim 6, wherein in the first step, the message ID included in the request message corresponds to a unique ID of the communication terminal and upload time.

8. The method set forth in claim 6, wherein in the first step, the number of total segments in the media data to be uploaded and the sequence number of the segment to be uploaded are included only in an initial request message and the size of the segment to be upload is included only in the initial and final request messages.

9. The method set forth in claim 6, wherein in the third step, the response message from the application server includes information on the sequence number of the segment from which the upload is to be resumed.

10. A method for controlling a media message upload through a wireless communication network, comprising the steps of:
a first step, conducted by a communication terminal, of sending a request message for an upload of media data to an application server through the wireless communication network;
a second step, conducted by the communication terminal, of uploading the media data by organizing the media data into a plurality of segments until a response message from the application server is received;
a third step, conducted by the communication terminal, of sending a request message for querying where to resume the upload to the application server if the connection between the communication terminal and the application server is closed during the upload of the media data;
a fourth step, conducted by the application server, of sending, responsive to the request message for querying where to resume the upload, a response message to the communication terminal;
a fifth step, conducted by the communication terminal, of resuming the upload of the media data from the segment to be uploaded; and
a sixth step, conducted by the application server, of sending a response message indicating normal completion of the media data upload to the communication terminal if the upload of the media data is completed.

11. The method set forth in claim 10, wherein the request message sent by the communication terminal in the first step includes the number of total segments in the media data to be uploaded, the sequence number of the segment to be uploaded, a message ID of the media data, the number of segments for which one acknowledgement response will be received from the application server, and the size of the segment to be uploaded given in bytes.

12. The method set forth in claim 11, wherein in the first step, the message ID included in the request message corresponds to a unique ID of the communication terminal and upload time.

13. The method set forth in claim 11, wherein in the first step, the number of total segments in the media data to be uploaded and the sequence number of the segment to be uploaded are included only in an initial request message and the size of the segment to be upload is included only in the initial and final request messages.

14. The method set forth in claim 11, wherein the request message for querying where to resume the upload sent by the communication terminal in the third step includes the message ID of the media data to be uploaded again.

15. The method set forth in claim 14, wherein in the fourth step, the response message from the application server includes information on the sequence number of the segment from which the upload is to be resumed.

16. A method for controlling a media message upload through a wireless communication network, comprising the steps of:
a first step, conducted by a communication terminal, of sending a request message for an upload of media data to an application server through the wireless communication network;
a second step, conducted by the communication terminal, of uploading the media data by organizing the media data into a plurality of segments until a response message from the application server is received;
a third step, conducted by the communication terminal, of sending a request message for canceling the upload of the media data if the upload is cancelled during the upload of the media data; and
a fourth step, conducted by the application server, of sending a response message if the request message for canceling the upload is received.

17. The method set forth in claim 16, wherein in the third step, the request message for canceling the upload of the media data includes the message ID of the media data the upload of which is to be canceled and the message status of the media data.

18. A method for controlling a media message upload through a wireless communication network, comprising the steps of:
a first step, conducted by a communication terminal, of sending a request message for an upload of media data to an application server through the wireless communication network;
a second step, conducted by the communication terminal, of uploading the media data by organizing the media data into a plurality of segments until a response message from the application server is received;
a third step, conducted by the application server, of calculating a time duration during which the application server does not receive a message from the communication terminal; and
a fourth step, conducted by the application server, of regarding the upload of the media data as canceled and deleting the temporary file of the uploaded data if the time duration exceeds a limit.

19. A method for controlling a media message upload through a wireless communication network, comprising the steps of:
a first step, conducted by a communication terminal, of sending a request message for an upload of media data to an application server through the wireless communication network and starting the upload of the media data if a response message is received from the application server;
a second step, conducted by the application server, of sending a response message if an upload error occurs during the upload of the media data;
a third step, conducted by the communication terminal, of sending a request message for resuming the upload of the media data;
a fourth step, conducted by the application server, of sending, responsive to the request message for resuming the upload, a response message to the communication terminal;
a fifth step, conducted by the communication terminal, of resuming the upload of the media data if the response message from the application server is received; and
a sixth step, conducted by the application server, of sending a response message indicating normal completion of the media data upload to the communication terminal if the resumed upload of the media data is completed.

20. The method set forth in claim 19, wherein the request message sent by the communication terminal in the first step includes the content of the media data, a unique ID of the message body of the media data, and content type information.

21. The method set forth in claim 20, wherein in the first step, the unique ID included in the request message corresponds to a unique ID of the communication terminal and upload time.

22. The method set forth in claim 20, wherein in the third step, the request message for resuming the upload of the media data includes the content length of the media data to be uploaded additionally, the range of the data to be uploaded additionally, and the unique ID of the message body of the media data the upload of which is to be resumed.

23. The method set forth in claim 20, wherein in the sixth step, the response message about the resumed upload of the media data includes the unique ID of the message body of the media data and text information about the upload result report.

24. A method for controlling a media message upload through a wireless communication network, comprising the steps of:
a first step, conducted by a communication terminal, of sending a request message for an upload of media data to an application server through the wireless communication network and starting the upload of the media data if a response message is received from the application server;
a second step, conducted by the communication terminal, of sending a request message for querying where to resume the upload to the application server if the connection between the communication terminal and the application server is closed during the upload of the media data;
a third step, conducted by the application server, of sending, responsive to the request message for querying where to resume the upload, a response message to the communication terminal;
a fourth step, conducted by the communication terminal, of sending a request message for resuming the upload to the application server if the response message from the application server is received;
a fifth step, conducted by the application server, of sending, responsive to the request message, a response message to the communication terminal;
a sixth step, conducted by the communication terminal, of starting the upload of the media data if the response message from the application server is received; and
a seventh step, conducted by the application server, of sending a response message indicating normal completion of the media data upload to the communication terminal after the resumed upload of the media data is completed.

25. The method set forth in claim 24, wherein the request message sent by the communication terminal in the first step includes the content of the media data, a unique ID of the message body of the media data, and content type information.

26. The method set forth in claim 25, wherein in the first step, the unique ID included in the request message corresponds to a unique ID of the communication terminal and upload time.

27. The method set forth in claim 25, wherein in the second step, the request message for querying where to resume the upload includes header field data match information for checking whether a portion of the message body that was previously uploaded exists in the application server.

28. The method set forth in claim 27, wherein in the third step, the response message for the request message for querying where to resume the upload includes the unique ID of the message body of the media data the upload of which is to be resumed and information on the range of the data that has been already uploaded.

29. The method set forth in claim 28, wherein in the fourth step, the request message for resuming the upload of the media data includes the content length of the media data to be uploaded additionally, the range of the data to be uploaded additionally, and the unique ID of the message body of the media data the upload of which is to be resumed.

30. The method set forth in claim 25, wherein in the seventh step, the response message about the resumed upload of the media data includes the unique ID of the message body of the media data and text information about the upload result report.

31. A method for controlling a media message upload through a wireless communication network, comprising the steps of:
a first step, conducted by a communication terminal, of sending a request message for uploading media data to an application server and uploading the media data; and
a second step, conducted by the application server, of sending a response message indicating that the upload is completed if the upload is completed normally.

32. A method for controlling a media message upload through a wireless communication network, comprising the steps of:
a first step, conducted by a communication terminal, of sending a request message for uploading media data to an application server and uploading the media data;
a second step, conducted by the application server, of ending an error code to the communication terminal if an upload error occurs;
a third step, conducted by the communication terminal, of resuming the upload of the media data based on the error code received from the application server; and
a fourth step, conducted by the application server, of sending a response message indicating that the upload is completed if the upload is completed normally.

33. The method set forth in claim 32, wherein in the third step, the communication terminal uploads the whole media data or a part of the media data depending on the received error code.
